(19) United States
(12) Patent Application Publication
(10) Pub. No.: US 2022/0398112 A1
(43) Pub. Date: Dec. 15, 2022

(54) USER INTERFACE ACCESSIBILITY NAVIGATION GUIDE

(71) Applicant: INTERNATIONAL BUSINESS MACHINES CORPORATION, ARMONK, NY (US)

(72) Inventors: Cindy Han Lu, San Jose, CA (US); Thai Quoc Tran, San Jose, CA (US); Srinivas R. Brahmaroutu, San Jose, CA (US)

(21) Appl. No.: 17/303,984

(22) Filed: Jun. 11, 2021

(51) Int. Cl. G06F 9/451

(52) U.S. Cl. CPC G06F 9/453

(57) ABSTRACT

A method is provided. The method may include, in response to electronically receiving on a first computing device a navigation file from a secondary computing device, generating a graphical navigation guide for a user interface (UI) based on the navigation file, wherein generating the graphical navigation guide comprises generating computer operations for the first computing device corresponding to the sequence of computer operations from the navigation file. The method may further include, based on the generated computer operations, executing the graphical navigation guide on the UI associated with the first computing device, wherein executing the graphical navigation guide comprises displaying a screen and a UI element corresponding to the sequence of computer operations, and wherein displaying the UI element comprises rendering an overlay on the UI element that highlights the UI element on the displayed screen and instructs a user to perform an input action on the UI element.

### BACKGROUND

The present invention relates generally to the field of computing, and more specifically, to generating a user interface navigation guide.

Generally, user interface accessibility and usability may include processes for making sure user interfaces are perceivable, operable, and understandable for people with a wide range of abilities. Typically, accessibility encompasses disabilities or functional limitations, including visual, auditory, physical, speech, cognitive, and neurological disabilities. However, accessibility also involves making products more usable by people in a wide range of situations. For example, situational limitations may be based on circumstances, environments, and conditions that can affect anybody including people without disabilities. Usability may be defined as the extent to which a product can be used by these different types of users and in these different types of situations to achieve specified goals effectively and efficiently. In turn, user interface accessibility and usability may be used to make sure that a user interface is designed to be effective, efficient, and satisfying for more people in more situations, which may require generating and incorporating assistive technologies.

### SUMMARY

A method is provided. The method may include, in response to electronically receiving on a first computing device a navigation file from a secondary computing device, generating a graphical navigation guide for a user interface (UI) associated with the first computing device based on the navigation file, wherein the navigation file comprises a sequence of computer operations based on user actions performed on the secondary computing device, and wherein generating the graphical navigation guide comprises generating computer operations for the first computing device corresponding to the sequence of computer operations from the navigation file. The method may further include, based on the generated computer operations, executing the graphical navigation guide on the UI associated with the first computing device, wherein executing the graphical navigation guide comprises displaying a screen and a UI element corresponding to the sequence of computer operations, and wherein displaying the UI element comprises rendering an overlay on the UI element that highlights the UI element on the displayed screen and instructs a user to perform an input action on the UI element.

A computer system is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may include, in response to electronically receiving on a first computing device a navigation file from a secondary computing device, generating a graphical navigation guide for a user interface (UI) associated with the first computing device based on the navigation file, wherein the navigation file comprises a sequence of computer operations based on user actions performed on the secondary computing device, and wherein generating the graphical navigation guide comprises generating computer operations for the first computing device corresponding to the sequence of computer operations from the navigation file. The method may further include, based on the generated computer operations, executing the graphical navigation guide on the UI associated with the first computing device, wherein executing the graphical navigation guide comprises displaying a screen and a UI element corresponding to the sequence of computer operations, and wherein displaying the UI element comprises rendering an overlay on the UI element that highlights the UI element on the displayed screen and instructs a user to perform an input action on the UI element.

A computer program product is provided. The computer program product may include one or more computer-readable storage devices and program instructions stored on at least one of the one or more tangible storage devices, the program instructions executable by a processor. The computer program product may include program instructions to, in response to electronically receiving on a first computing device a navigation file from a secondary computing device, generate a graphical navigation guide for a user interface (UI) associated with the first computing device based on the navigation file, wherein the navigation file comprises a sequence of computer operations based on user actions performed on the secondary computing device, and wherein the program instructions to generate the graphical navigation guide comprises program instructions to generate computer operations for the first computing device corresponding to the sequence of computer operations from the navigation file. The computer program product may include program instructions to, based on the generated computer operations, execute the graphical navigation guide on the UI associated with the first computing device, wherein the program instructions to execute the graphical navigation guide comprises program instructions to display a screen and a UI element corresponding to the sequence of computer operations, and wherein the program instructions to display the UI element comprises program instructions to render an overlay on the UI element that highlights the UI element on the displayed screen and instructs a user to perform an input action on the UI element.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to one embodiment;

FIG. 2 is a diagram illustrating an example of a graphical navigation guide according to one embodiment;

FIG. 3 is an operational flowchart illustrating the steps carried out by a program for generating and dynamically executing a graphical navigation guide on a UI according to one embodiment;

FIG. 4 is a block diagram of the system architecture of the program for generating and dynamically executing a graphical navigation guide on a UI according to one embodiment;

FIG. 5 is a block diagram of an illustrative cloud computing environment including the computer system depicted in FIG. 1, in accordance with an embodiment of the present disclosure; and

FIG. 6 is a block diagram of functional layers of the illustrative cloud computing environment of FIG. 5, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate generally to the field of computing, and more particularly, to a user interface (UI) navigation guide. The following described exemplary embodiments provide a system, method and program product for generating and dynamically executing a graphical navigation guide on a UI. Specifically, the present embodiment has the capacity to improve the technical field associated with user interfaces by generating and executing a graphical navigation guide on a first device based on user actions performed on a second device. More specifically, the system, method and program product may track and collect user action data with respect to user interface (UI) elements on a secondary device Then, the system, method and program product may create a navigation file, the navigation containing the tracked collected user action data as a sequential set of steps. Furthermore, the system, method and program product may send the navigation file to the first device, and in turn, generate instruction to follow based on a set of steps in the navigation file from the second device.

As previously described with respect to user interface accessibility and usability, a user interface may be designed to be effective, efficient, and satisfying for more people in more situations. However, despite design implications for making a user interface effective and efficient, different types of people may still require assistive technology for using a user interface to achieve specified goals. For example, elderly individuals often have trouble using an operating system, and a user interface associated with an operating system, for a mobile device. More specifically, for example, an elderly individual may accidentally turn off a mobile phone's volume, delete an app, or turn off notifications for an app due to the elderly individual's lack of understanding of a device and user interface. Specifically, to change certain settings of an interface or change device settings in general, an elderly individual would often have to understand how to navigate through a complex series of screens and user interface elements to get to a place where the settings can be changed. While reading a step-by-step document guide on the mobile device may be a resolution, this resolution is often cumbersome in that an individual typically has to constantly switch between reading the document guide and actually performing guided actions on a screen, which may lead an individual (such as an elderly individual) to lose navigation progress.

As such, it may be advantageous, among other things, to provide a method, computer system, and computer program product for generating and executing a graphical navigation guide that may directly and dynamically navigate a user through user interface elements associated with a user interface (UI). Specifically, in a use case scenario, a first user using a first computing device may have difficulty adjusting settings on the first computing device. In this scenario, the first user may notify a second user, whereby the second user may be using a secondary computing device that is separate from the first computing device. The second user may want to help instruct the first user on how to change the settings. As such, the method, computer system, and computer program product may detect and capture the second user's actions on the secondary computing device, whereby capturing the second user's actions may include capturing computer instructions associated with the second user's interactions with UI elements on the secondary computing device. Thereafter, the method, computer system, and computer program product may store the computer instructions corresponding to the captured second user's actions as a navigation file on the secondary computing device. Then, the method, computer system, and computer program product may share the navigation file including the computer instructions to a first computing device, whereby the shared navigation file that includes the computer instructions may be provided to the first computing as a set of sequential operations/steps.

Specifically, the method, computer system, and computer program product, method, computer system, and computer program product may receive and open the shared navigation file on the first computing device. Thereafter, the method, computer system, and computer program product may identify and extract from the shared navigation file the computer instructions and the sequential operations associated with the interacted UI elements on the secondary device. In turn, the method, computer system, and computer program product may interpret the extracted computer instructions and interacted with UI elements to identify corresponding UI elements on the first computing device. Then, based on the extracted data as well as the identification of the corresponding UI elements on the first computing device, the method, computer system, and computer program product may generate a graphical navigation guide for guiding the first user through a user interface on the first computing device to achieve a specified goal (such as adjusting a certain setting). In turn, the method, computer system, and computer program product may execute the graphical navigation guide by launching a screen and/or sequence of screens on the first computing device to present the corresponding UI elements, whereby the sequence of screens and corresponding UI elements may be presented according to the specific order of the second user's interactions with the secondary computing device. Specifically, the method, computer system, and computer program product may navigate the first user through the sequence of screens by highlighting specific UI elements on a corresponding screen as the specific UI elements are presented. More specifically, the method, computer system, and computer program product may highlight each of the UI elements in the sequence of screens by generating and rendering a UI overlay for each of the UI elements, whereby a UI overlay may include a UI overlay window and text indicating that an input action is needed on the UI element.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

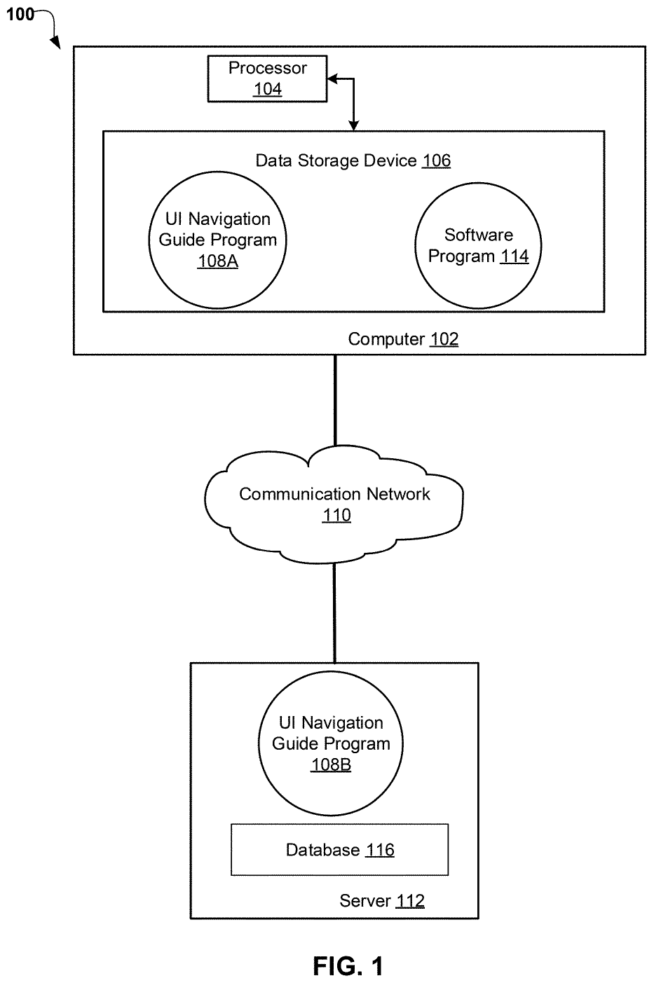

Referring now to FIG. 1, an exemplary networked computer environment 100 in accordance with one embodiment is depicted. The networked computer environment 100 may include a computer 102 with a processor 104 and a data storage device 106 that is enabled to run a user interface (UI) navigation guide program 108A and a software program 114 and may also include a microphone (not shown). The software program 114 may be an application program such as a messaging application and/or one or more mobile apps (such as a web browsing app) running on a computer 102, such as a mobile phone device. The UI navigation guide program 108A may communicate with the software program 114. The networked computer environment 100 may also include a server 112 that is enabled to run a UI navigation guide program 108B and the communication network 110. The networked computer environment 100 may include multiple computers 102 and servers 112, only one of which is shown for illustrative brevity. For example, the plurality of computers 102 may include a plurality of interconnected devices, such as a mobile phone, tablet, and laptop, associated with one or more users.

According to at least one implementation, the present embodiment may also include a database 116, which may be running on server 112. The communication network 110 may include various types of communication networks, such as a wide area network (WAN), local area network (LAN), a telecommunication network, a wireless network, a public switched network and/or a satellite network. It may be appreciated that FIG. 1 provides only an illustration of one implementation and does not imply any limitations with regard to the environments in which different embodiments may be implemented. Many modifications to the depicted environments may be made based on design and implementation requirements.

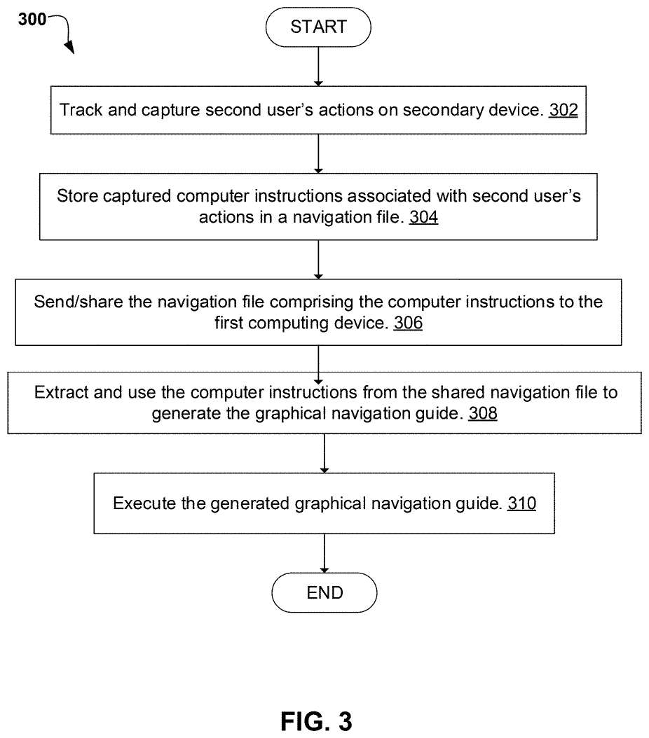

The computer 102 may communicate with server 112 via the communications network 110. The communications network 110 may include connections, such as wire, wireless communication links, or fiber optic cables. As will be discussed with reference to FIG. 3, server 112 may include internal components 800a and external components 900a, respectively, and computer 102 may include internal components 800b and external components 900b, respectively. Server 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Computer 102 may be, for example, a mobile device, a telephone, a personal digital assistant, a netbook, a laptop computer, a tablet computer, a desktop computer, or any type of computing device capable of running a program and accessing a network. According to various implementations of the present embodiment, the UI navigation guide program 108A, 108B may interact with a database 116 that may be embedded in various storage devices, such as, but not limited to, a computer 102, a networked server 112, or a cloud storage service.

According to the present embodiment, a program, such as a UI navigation guide program 108A and 108B may run on the computer 102 and/or on the server 112 via a communications network 110. According to one embodiment, computer 102 may be a mobile phone device having an operating system (OS) that includes a user interface (UI). The UI navigation guide program 108A, 108B may generate and execute a graphical navigation guide that may directly and dynamically navigate a user through UI elements associated with the UI to achieve a specified goal. Specifically, a first user using a first computer 102 may run a UI navigation guide program 108A, 108B to generate and execute a graphical navigation guide based on captured user actions from a secondary computer 102, whereby the captured user actions may include captured computer instructions associated with a second user's interaction with UI elements on the secondary computer 102. According to one embodiment, the captured second user's interactions may be stored as computer instructions in a navigation file, such as a text file, on the secondary computer 102. Thereafter, the UI navigation guide program 108A, 108B may share the file that includes the captured second user's interactions to the first computer 102, whereby the first computer 102 may be a computer that is separate from the secondary computer 102 (as previously described, networked computer environment 100 may include multiple computers 102 and servers 112, only one of which is shown for illustrative brevity). In turn, the UI navigation guide program 108A, 108B may read the computer instructions from the shared navigation file to generate and execute graphical navigation guide that may guide/navigate a first user through screens and UI elements located on the first computer that correspond to UI elements and an order of operations based on the shared navigation file.

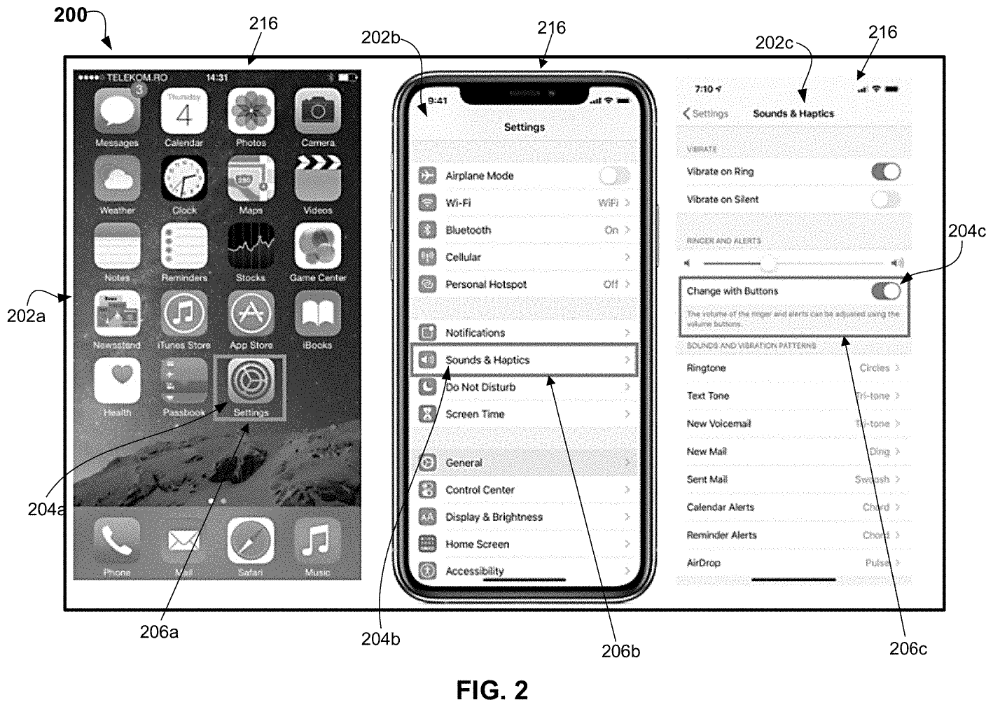

More specifically, and referring now to FIG. 2, a diagram illustrating an example of a graphical navigation guide 200 according to one embodiment is depicted. As previously described, the UI navigation guide program 108A, 108B may generate and dynamically execute a graphical navigation guide that may assist a user in navigating through UI elements 204a, 204b, 204c for achieving a specified goal on a computer 102 (FIG. 1). As depicted in FIG. 2, the computer 102 (FIG. 2) may be a mobile phone device 216. The mobile phone device 216 may include an operating system (OS) with a user interface (UI) 226. The UI may include different screens 202a, 202b, 202c whereby the different screens may include different UI elements 204a, 204b, 204c. The UI elements may, for example, include buttons, tabs, toggles, radio buttons, app icon buttons, dropdown menus, and other elements located on the UI. More specifically, for example, a first screen 202a of a UI may include a UI element 204 such as a Settings app icon that corresponds to a mobile and/or system app stored on the mobile phone device 216. Also, for example, a second screen 202b may be a sub-screen of the first screen 202a, whereby the second screen 202b may be accessed and displayed as result of a user clicking on the Settings app icon 204a from the first screen 202a. The second screen 202b may also include a UI element 204b such as a Sound & Haptics menu button. Furthermore, for example, a third screen 202c may be a sub-screen of the second screen 202b, whereby the third screen may be accessed and displayed as result of a user clicking on the Sound & Haptics menu button 204b from the second screen 202b. The third screen 202b may also include a UI element 204c such as a toggle button for toggling between a certain feature associated with the mobile phone device 216.

Specifically, in a use case scenario, a user using the mobile phone device 216 in FIG. 2 may have difficulty adjusting audio for alerts and notifications received on the mobile phone device 216. As such, the UI navigation guide program 108A, 108B may generate and dynamically execute a graphical navigation guide that may dynamically provide interactive step-by-step navigation through the UI elements 204a, 204b, 204c for achieving a specific goal such as adjusting the audio for alerts and notifications received on the mobile phone device 216. According to one embodiment, and as will be further described with respect to FIG. 3, the graphical navigation guide may be based in part on captured/recorded user actions from a secondary computing device. Specifically, the UI navigation guide program 108A, 108B may use the captured user actions from the secondary computing device to generate and execute the graphical navigation guide on the first computing device, such as the mobile phone device 216, that is separate from the secondary computing device. In turn, the UI navigation guide program 108A, 108B may execute the graphical navigation guide which may include displaying a sequence of screens 202a, 202b, 202c on the mobile phone device 216 and highlighting specific UI elements 204a, 204b, 204c on the sequence of screens 202a, 202b, 202c that may represent necessary steps for adjusting the audio for alerts and notifications (according to the captured user actions). More specifically, the UI navigation guide program 108A, 108B may highlight each UI element 204a, 204b, 204c in the sequence of screens 202a, 202b, 202c by generating a UI overlay 206a, 206b, 206c over each of the UI elements 204a, 204b, 204c to indicate to a user that action is needed on the UI element 204a, 204b, 204c.

According to one embodiment, the UI overlay 206a, 206b, 206c may be a graphical object and/or text that is added to (or highlights) UI elements 204a, 204b, 204c. Specifically, for example, the UI overlay 206a, 206b, 206c may include a UI overlay window 206a, 206b, 206c (as shown in FIG. 2), and/or graphically added text (not shown) that may indicate to the first user that user input/action is needed. According to one embodiment, a UI overlay window 206a, 206b, 206c may be displayed on the screens 202a, 202b, 202c as a graphical border that outlines and encloses a specific UI element 204a, 204b, 204c. Specifically, according to one embodiment, the UI navigation guide program 108A, 108B may include computer instructions for determining a size of a UI element. In turn, the UI navigation guide program 108A, 108B may generate a UI overlay window 206a, 206, 206c that corresponds to the size of a respective UI element 204a, 204b, 204c. Additionally, the UI overlay may include an indication, such as text, with the UI overlay window 206a, 206b, 206c to further indicate to a user that input is needed on the UI element 204a, 204b, 204c to navigate to a next screen 202a, 202b, 202c and/or UI element 204a, 204b, 204c in the sequence of screens 202a, 202b, 202c and UI elements 204a, 204b, 204c. For example, the indication may include text, such as “Click Here,” and an arrow pointing to a UI element 204a, 204b, 204c and corresponding UI overlay window 206a, 206b, 206c.

Therefore, continuing from the previous example, in response to initiating the graphical navigation guide, the UI navigation guide program 108A, 108B may identify and present a first UI element 204a on the first screen 202a, whereby the first UI element 204a may be associated with a first step in a multi-step sequence for adjusting the audio for alerts and notifications. Specifically, the UI navigation guide program 108A, 108B may indicate to a user that a first step for adjusting the audio may include clicking on a Settings icon button 204a that may be used for accessing the settings associated with the mobile phone device 216. More specifically, the UI navigation guide program 108A, 108B may indicate that the user should click on the Settings icon button 204a by displaying the previously described UI overlay 206a over the Settings icon button 204a. Thereafter, in response to the user clicking on the Settings icon button 204a, the UI navigation guide program 108A, 108B may be triggered to identify and present a second UI element 204b on the second screen 202b, whereby the second UI element 204b may be associated with a second step in the multi-step process for adjusting the audio for alerts and notifications. Specifically, in the second step associated with the graphical navigation guide, the UI navigation guide program 108A, 108B may indicate that the user should click on the Sounds & Haptics menu button 204b by displaying the UI overlay 206b over the Sounds & Haptics menu button 204b. Next, in response to the user clicking on the Sounds & Haptics menu button 204b, the UI navigation guide program 108A, 108B may be triggered to identify and present a third UI element 204c on the third screen 202c, whereby the third UI element 204c may be associated with a third and final step in the multi-step process for adjusting the audio for alerts and notifications. Specifically, in the third step associated with the graphical navigation guide, the UI navigation guide program 108A, 108B may indicate that the user should use the toggle button 204c to toggle whether to use the volume up and down keys on the mobile phone device 216 to adjust the audio for alerts and notifications. More specifically, the UI navigation guide program 108A, 108B may indicate to the user to use the toggle button 204c by displaying the previously described UI overlay 206c over the toggle button 204c.

Referring now to FIG. 3, an operational flowchart 300 illustrating the steps carried out by a program for generating and dynamically executing a graphical navigation guide on a UI according to one embodiment is depicted. Specifically, at 302, the UI navigation guide program 108A, 108B (FIG. 1) may track and capture a second user's actions on a secondary computing device. As previously described in the use case scenario discussed in FIG. 2, the graphical navigation guide may be based in part on captured/recorded user actions from a secondary computing device. Specifically, and as previously described in the use case scenario, a first user using the mobile phone device 216 in FIG. 2 may have difficulty adjusting audio for alerts and notifications received on the mobile phone device 216. In this scenario, the first user may notify a second user, whereby the second user may be using the secondary computing device (such as a mobile phone device) that is separate from the first computing device (i.e. such as mobile phone device 216), whereby the first computing device and the secondary computing device may include a same or similar operating system (OS). In turn, the UI navigation guide program 108A, 108B (FIG. 1) may be initiated on the secondary computing device to track and record/capture second user's actions performed on the secondary computing device. Continuing from the previous example described in FIG. 2, the captured second user's actions may represent steps for adjusting the audio for alerts and notifications on a specific type of user interface.

According to one embodiment, initiating the UI navigation guide program 108A, 108B (FIG. 1) may include triggering the UI navigation guide program 108A, 108B (FIG. 1) to start tracking and capturing the computer instructions associated with the second user's actions on the secondary computing device. Furthermore, according to one embodiment, the UI navigation guide program 108A, 108B (FIG. 1) may be initiated in different manners. For example, the UI navigation guide program 108A, 108B (FIG. 1) may be initiated on the secondary computing device in response to the second user performing an action such as: a) double tapping a power button on the secondary computing device; a) pressing on a down volume key and power button at the same time on the secondary computing device; or c) directly accessing the UI navigation guide program 108A, 108B (FIG. 1) on the secondary computing device (whereby the UI navigation guide program 108A, 108B may be a mobile app or setting on the secondary computing device), and clicking on a Start Recording button on the UI navigation guide program 108A, 108B (FIG. 1). Also, according to one embodiment, the tracking and recording may be stopped in the same or different manner as described above for initiating the UI navigation guide program 108A, 108B (FIG. 1). Many modifications may be made to the manner in which the UI navigation guide program 108A, 108B (FIG. 1) is initiated and stopped based on device and design settings.

Thereafter, in response to initiation, the UI navigation guide program 108A, 108B (FIG. 1) may begin tracking and capturing the second user's actions on the secondary computing device, whereby tracking and capturing the second user's actions may include tracking and capturing computer instructions/operations corresponding to the second user's interactions with the UI elements on the secondary computing device. According to one embodiment, the UI navigation guide program 108A, 108B (FIG. 1) may leverage the OS by using user interface (UI) hooks to capture the computer instructions associated with second user's actions on the secondary computing device. Generally, a UI hook may be a computer instruction and/or subroutine that may be added to computer instructions associated with the OS and used by the UI navigation guide program 108A, 108B (FIG. 1) to monitor and intercept events, such as mouse actions, touch screen actions, and keystrokes. A UI hook function that intercepts a particular type of user event may be known as a hook procedure. According to one embodiment, the computer instructions and corresponding user event data associated with the second user's actions that is captured by a UI hook may, for example, include OS data, operations performed by the OS, code language data, timestamp data, screen data, screen sequence data, UI element identifiers, UI element sequence data, and metadata. Accordingly, the second user may perform actions on the secondary computing device that may correspond to adjusting the audio for alerts and notifications, whereby an order/sequence of operations associated with the second user's actions may include:

///
scroll right
Click on Settings
scroll down
Click on Sounds & Haptics
Ringer and Alerts >> Change with Buttons toggle button, switch
to ON mode
///.

As such, according to one embodiment, the computer instructions may include underlying code associated with the second user's actions such as:

<tab
id=″Settings″ onclick=″gotoSettingsScreen( )″>Settings</tab>
. . .
<tab
id=″Sounds&HapticsSetting″onclick=
″gotoSound&HapticsSubScreen( )″>Sounds&Haptics</tab>
. . .
< Toggle id=″RingerandAlerts″ ontoggle=
onToggle(′ChangewithButtons′)″></Toggle>
. . . .

Therefore, based on the second user's action (onClickSettings, onClickSounds&HapticsSub Screen, onToggleChangewithButtons), the UI navigation guide program 108A, 108B (FIG. 1) may use the UI hook to track and capture the computer instructions associated with the second user's actions. As will be further described at step 308, the captured computer instructions may, in turn, be used by the UI navigation guide program 108A, 108B (FIG. 1) to determine the sequence of operations/steps for adjusting the audio for alerts and notifications. Specifically, based on the captured computer instructions, the UI navigation guide program 108A, 108B (FIG. 1) may detect that a sequence of operations (and corresponding UI elements) of the second user's actions may include: onClickSettings>onClickSounds&Haptics>ToggleRingerandAlertsChangewithButtons.

Thereafter, at 304, the UI navigation guide program 108A, 108B (FIG. 1) may store the captured computer instructions associated with the second user's actions in a navigation file that may be located on a database/memory associated with the secondary computing device. Specifically, the UI navigation guide program 108A, 108B (FIG. 1) may store the navigation file in any suitable format that may be read and/or decrypted by an OS that is compatible with the OS associated with the secondary computing device. As a general example, image files may be stored using a file extension such as png, jpg, bmp, etc. The file extension may notify an OS of the type of file and how to open the contents of the file. In some cases, an application may be used to open an image file (such as paint, photoshop, etc). In turn, the OS and/or application will know how to open a file using some type of algorithm to decrypt the contents. As such, for example, the UI navigation guide program 108A, 108B (FIG. 1) may store the contents of the captured computer instructions associated with the second user's actions in a text file (with file extension .txt), whereby the text file may include a set of sequential operations/steps and other event data such as the timestamp data, the UI element identifiers, metadata, etc. An example text script included in a text file based on the above second user's actions may be:
0:00, general Settings.tab.onClickSettings, goToSettingsScreen, and metadata
0:12 generalSettings.tab.onClickSoundsHaptics, gotoSoundHapticsSub Screen, and metadata
0:22 generalSettings.tab.RingerandAlerts.onToggleChangewithButtons, ToggleOnandOff, and metadata.

Then, at 306, the UI navigation guide program 108A, 108B (FIG. 1) may send/share the stored navigation file that includes the computer instructions associated with the second user's action to a first computing device. According to one embodiment, the UI navigation guide program 108A, 108B (FIG. 1) may include a messaging interface (such as a chat interface) to, for example, send the stored navigation file to a contact corresponding to the first computing device. According to another embodiment, the UI navigation guide program 108A, 108B (FIG. 1) may connect to a separate multimedia messaging service on the secondary computing device to send the stored navigation file to the contact associated with the first computing device. For example, and as previously described with respect to FIG. 1, the UI navigation guide program 108A, 108B (FIG. 1) may interact with a software program 114 (FIG. 1), whereby the software program may, for example, include a mobile messaging app on the secondary computing device. In either case, based on a second user's action with the chat or messaging service (such as attaching the stored navigation file to a message), the UI navigation guide program 108A, 108B (FIG. 1) may send/share the stored navigation file that includes the computer instructions and other event data associated with the second user's action to the first computing device.

Thereafter, at 308, in response to receiving and opening the shared navigation file on the first computing device, the UI navigation guide program 108A, 108B (FIG. 1) may extract and use the computer instructions and other event data from the shared navigation file to generate a graphical navigation guide. According to one embodiment, and as previously described, the first computing device may receive the shared navigation file via the chat/messaging interface associated with the UI navigation guide program 108A, 108B (FIG. 1), whereby the chat/messaging service associated with the UI navigation guide program 108A, 108B (FIG. 1) may be similarly used on the first computing device for receiving and opening the shared navigation file. Also, according to one embodiment, the first computing device may receive the shared navigation file via a separate messaging service, such as a mobile messaging app located on the first computing device, whereby the first user may open the sent/shared navigation file via the UI navigation guide program 108A, 108B (FIG. 1). Thereafter, and in response to receiving and opening the shared navigation file, the UI navigation guide program 108A, 108B (FIG. 1) located on the first computing device may use contents from the shared navigation file to generate the graphical navigation guide. Specifically, according to one embodiment, the UI navigation guide program 108A, 108B (FIG. 1) may automatically begin a process for generating the graphical navigation guide or may prompt the first user with a dialog box. For example, the UI navigation guide program 108A, 108B (FIG. 1) may present a dialog box prompting the first user by asking the first user whether or not the first user would like to generate the graphical navigation guide based on the contents (i.e. the computer instructions and other event data) in the shared navigation file.

In turn, according to one embodiment, the UI navigation guide program 108A, 108B (FIG. 1) may generate the graphical navigation guide by first determining whether the computer instructions and data from the shared navigation file are based on an OS that is compatible with the OS on the first computing device. As previously described, the shared navigation file may include captured computer instructions and corresponding user event data based on the second user's actions on the secondary computing device, whereby the captured computer instructions and corresponding user event data may include, among other things, OS data. Therefore, based on the captured computer instructions and user event data, the UI navigation guide program 108A, 108B (FIG. 1) may compare the OS data associated with the shared navigation filed to the OS data associated with the first computing device. The UI navigation guide program 108A, 108B (FIG. 1) may use the comparison of the OS data to determine whether the computer instructions from the shared navigation file may be read by and/or interpreted for the OS associated with the first computing device for generating the graphical navigation guide. For example, based on the comparison of the OS data from the shared navigation file and the OS associated with the first computing device, the UI navigation guide program 108A, 108B (FIG. 1) may determine that the operating systems may be the same or may be compatible versions of the same OS. According to one embodiment, in response to the UI navigation guide program 108A, 108B (FIG. 1) determining that the operating systems are not compatible, the UI navigation guide program 108A, 108B (FIG. 1) may present an error on the first computing device.

In turn, based on a determination that the operating systems are compatible, the UI navigation guide program 108A, 108B (FIG. 1) may extract and use the computer instructions and corresponding user event data from the shared navigation file to generate the graphical navigation guide. Specifically, the UI navigation guide program 108A, 108B (FIG. 1) may read the computer instructions and user event data from the shared navigation file to determine the order of operations associated with the second user's actions on the secondary computing device as well as the UI elements corresponding to the order of operations. As previously described at step 306, for example, the captured computer instructions in the shared navigation file may be used by the UI navigation guide program 108A, 108B (FIG. 1) to determine an order of operations (or steps) for adjusting the audio for alerts and notifications. Specifically, based on the read data from the computer instructions, the UI navigation guide program 108A, 108B (FIG. 1) may detect that an order of operations of the second user's actions may include: onClickSettings>onClickSounds&Haptics>ToggleRingerandAlertsChangewithButtons. The UI navigation guide program 108A, 108B (FIG. 1) may further determine that the UI elements associated with the order of operations includes a Settings icon button, a Sounds & Haptics menu button, and a toggle button for a Change with Buttons menu item under a Ringer and Alerts tab.

In turn, the UI navigation guide program 108A, 108B (FIG. 1) may identify the same and/or compatible UI elements on the first computing device that correspond to the UI elements identified in the data read from the computer instructions associated with the shared navigation file. For example, the UI navigation guide program 108A, 108B (FIG. 1) may further use/leverage the OS data associated with the first computing device to identify the Settings icon button on the first computing device and the location of the Settings icon on the first computing device (such as identifying that the Settings icon button 204a may be located on a first screen 202a). Furthermore, the UI navigation guide program 108A, 108B (FIG. 1) may further use the OS data to identify the Sounds & Haptics menu button on the first computing device and the location of the Sounds & Haptics menu button on the first computing device (such as identifying that the Sounds & Haptics menu button 204b may be located on a second screen 202b). Additionally, the UI navigation guide program 108A, 108B (FIG. 1) may further use the OS data to identify the toggle button for a Change with Buttons menu item under a Ringer and Alerts tab (such as identifying that the toggle button 204c may be located on a third screen 202c).

Thereafter, based on the computer instructions from the shared navigation file and the identified UI elements on the first computing device, the UI navigation guide program 108A, 108B (FIG. 1) may generate the graphical navigation guide. Specifically, the UI navigation guide program 108A, 108B (FIG. 1) may generate the graphical navigation guide by generating computer instructions that are executable by the OS on the first computing device and that correspond to the computer instructions and sequence of operations from the shared navigation file. Furthermore, and as described in FIG. 2, the generated computing instructions may include computer instructions for generating and displaying the UI overlays on the UI elements in the sequence of operations. More specifically, the generated computer instructions for the graphical navigation guide may navigate a user through each UI element identified on the first computing device according to the sequences of operations associated with the shared navigation file from the second computing device. Additionally, and a previously described in FIG. 2, a UI overlay 206a, 206b, 206c may be used, whereby the UI overlay includes a UI overlay window 206a, 206b, 206c (as shown in FIG. 2) and may also include text (not shown) that may indicate to the first user that user input/action is needed. According to one embodiment, the UI overlay window 206a, 206b, 206c may be displayed on the screens 202a, 202b, 202c as a border that outlines and encloses a specific UI element 204a, 204b, 204c. Specifically, according to one embodiment, the UI navigation guide program 108A, 108B may include computer instructions for determining a size of a UI element. In turn, the UI navigation guide program 108A, 108B may generate a UI overlay window 206a, 206, 206c that corresponds to the size of a respective UI element 204a, 204b, 204c. Furthermore, the UI overlay may include an indication, such as text, with the UI overlay window 206a, 206b, 206c to further indicate to a user that input is needed on the UI element 204a, 204b, 204c to navigate to a next screen 202a, 202b, 202c and/or UI element 204a, 204b, 204c in the sequence of screens 202a, 202b, 202c and UI elements 204a, 204b, 204c. For example, the indication may include text, such as “Click Here,” and an arrow pointing to a UI element 204a, 204b, 204c and corresponding UI overlay window 206a, 206b, 206c.

Next at 310, the UI navigation guide program 108A, 108B (FIG. 1) may initiate/execute the graphical navigation guide by carrying out the generated computer instructions on the first computing device. According to one embodiment, the UI navigation guide program 108A, 108B (FIG. 1) may automatically initiate the graphical navigation guide in response to generating the graphical navigation guide. According to another embodiment, in response to generating the graphical navigation guide, the UI navigation guide program 108A, 108B (FIG. 1) may prompt the first user with a dialog box to ask the first user whether the first user would like to initiate the graphical navigation guide. In either case, in response to initiating the graphical navigation guide, the UI navigation guide program 108A, 108B (FIG. 1) may execute the generated computer instructions that may navigate the first user through each UI element identified on the first computing device according to the order of operations associated with the shared navigation file received from the secondary computing device.

Specifically, and as previously described in FIG. 2, based on the example of adjusting audio for alerts and notifications, the UI navigation guide program 108A, 108B may identify and present on the first computing device a first UI element 204a on the first screen 202a, whereby the first UI element 204a may be associated with a first step in a multi-step process for adjusting the audio for alerts and notifications. Specifically, the UI navigation guide program 108A, 108B may indicate to the first user that a first step for adjusting the audio may include clicking on a Settings icon button 204a that may be used for accessing the settings associated with the mobile phone device 216. More specifically, the UI navigation guide program 108A, 108B may indicate that the first user should click on the Settings icon button 204a by displaying the previously described UI overlay 206a over the Settings icon button 204a (and possibly text, such as Click Here). Thereafter, in response to the first user clicking on the Settings icon button 204a, the UI navigation guide program 108A, 108B may be triggered to identify and present a second UI element 204b on the second screen 202b, whereby the second UI element 204b may be associated with a second step in the multi-step process for adjusting the audio for alerts and notifications. Specifically, in the second step associated with the graphical navigation guide, the UI navigation guide program 108A, 108B may indicate that the first user should click on the Sounds & Haptics menu button 204b by displaying the UI overlay 206b over the Sounds & Haptics menu button 204b. Next, in response to the first user clicking on the Sounds & Haptics menu button 204b, the UI navigation guide program 108A, 108B may be triggered to identify and present a third UI element 204c on the third screen 202c, whereby the third UI element 204c may be associated with a third and final step in the multi-step process for adjusting the audio for alerts and notifications. Specifically, in the third step associated with the graphical navigation guide, the UI navigation guide program 108A, 108B may indicate that the first user should use the toggle button 204c to toggle whether to use the volume up and down keys on the mobile phone device 216 to adjust the audio for alerts and notifications. More specifically, the UI navigation guide program 108A, 108B may indicate to the first user to use the toggle button 204c by displaying the previously described UI overlay 206c over the toggle button 204c.

It may be appreciated that FIGS. 1-3 provide only illustrations of one implementation and does not imply any limitations with regard to how different embodiments may be implemented. Many modifications to the depicted environments may be made based on design and implementation requirements. For example, in step 308, the UI navigation guide program 108A, 108B (FIG. 1) may include machine and/or deep learning algorithms for converting the captured computer instructions from the first computing device having a first type of OS into readable data for a second type of OS associated with the second computing device in the user event the first computing device and the second computing device have different operating systems. For example, the UI navigation guide program 108A, 108B (FIG. 1) may include a repository (i.e. a database) of sample OS data and computer coding languages which may be used by the machine/deep learning algorithms to convert computer instructions to a readable format for a respective OS.

The present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

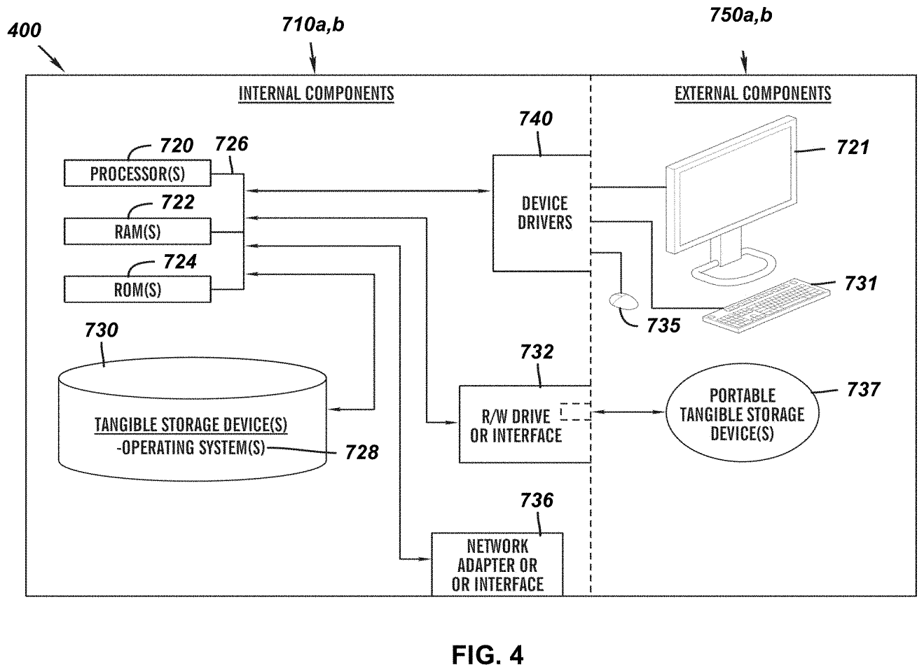

FIG. 4 is a block diagram 400 of internal and external components of computers depicted in FIG. 1 in accordance with an illustrative embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

Data processing system 710, 750 is representative of any electronic device capable of executing machine-readable program instructions. Data processing system 710, 750 may be representative of a smart phone, a computer system, PDA, or other electronic devices. Examples of computing systems, environments, and/or configurations that may represented by data processing system 710, 750 include, but are not limited to, personal computer systems, server systems, thin clients, thick clients, hand-held or laptop devices, multiprocessor systems, microprocessor-based systems, network PCs, minicomputer systems, and distributed cloud computing environments that include any of the above systems or devices.

User computer 102 (FIG. 1), and network server 112 (FIG. 1) include respective sets of internal components 710 a, b and external components 750 a, b illustrated in FIG. 4. Each of the sets of internal components 710 a, b includes one or more processors 720, one or more computer-readable RAMs 722, and one or more computer-readable ROMs 724 on one or more buses 726, and one or more operating systems 728 and one or more computer-readable tangible storage devices 730. The one or more operating systems 728, the software program 114 (FIG. 1) and the UI navigation guide program 108A (FIG. 1) in computer 102 (FIG. 1), and the UI navigation guide program 108B (FIG. 1) in network server 112 (FIG. 1) are stored on one or more of the respective computer-readable tangible storage devices 730 for execution by one or more of the respective processors 720 via one or more of the respective RAMs 722 (which typically include cache memory). In the embodiment illustrated in FIG. 4, each of the computer-readable tangible storage devices 730 is a magnetic disk storage device of an internal hard drive. Alternatively, each of the computer-readable tangible storage devices 730 is a semiconductor storage device such as ROM 724, EPROM, flash memory or any other computer-readable tangible storage device that can store a computer program and digital information.

Each set of internal components 710 a, b, also includes a R/W drive or interface 732 to read from and write to one or more portable computer-readable tangible storage devices 737 such as a CD-ROM, DVD, memory stick, magnetic tape, magnetic disk, optical disk or semiconductor storage device. A software program, such as an UI navigation guide program 108A and 108B (FIG. 1), can be stored on one or more of the respective portable computer-readable tangible storage devices 737, read via the respective R/W drive or interface 732, and loaded into the computer-readable tangible storage devices 730.

Each set of internal components 710 a, b also includes network adapters or interfaces 736 such as a TCP/IP adapter cards, wireless Wi-Fi interface cards, or 3G or 4G wireless interface cards or other wired or wireless communication links. The UI navigation guide program 108A (FIG. 1) and software program 114 (FIG. 1) in computer 102 (FIG. 1), and the UI navigation guide program 108B (FIG. 1) in network server 112 (FIG. 1) can be downloaded to computer 102 (FIG. 1) from an external computer via a network (for example, the Internet, a local area network or other, wide area network) and respective network adapters or interfaces 736. From the network adapters or interfaces 736, the UI navigation guide program 108A (FIG. 1) and software program 114 (FIG. 1) in computer 102 (FIG. 1) and the UI navigation guide program 108B (FIG. 1) in network server 112 (FIG. 1) are loaded into the computer-readable tangible storage devices 730. The network may comprise copper wires, optical fibers, wireless transmission, routers, firewalls, switches, gateway computers, and/or edge servers.

Each of the sets of external components 750 a, b can include a computer display monitor 721, a keyboard 731, and a computer mouse 735. External components 750 a, b can also include touch screens, virtual keyboards, touch pads, pointing devices, and other human interface devices. Each of the sets of internal components 710 a, b also includes device drivers 740 to interface to computer display monitor 721, keyboard 731, and computer mouse 735. The device drivers 740, R/W drive or interface 732, and network adapter or interface 736 comprise hardware and software (stored in storage device 730 and/or ROM 724).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

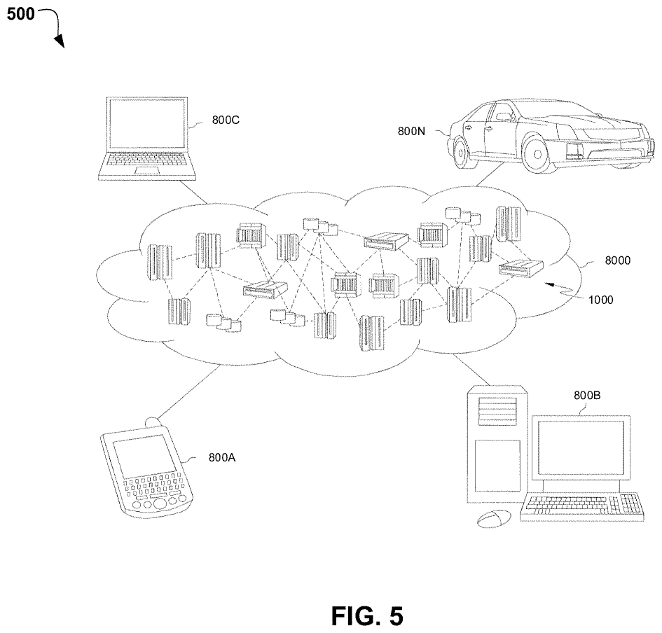

Referring now to FIG. 5, illustrative cloud computing environment 500 is depicted. As shown, cloud computing 8000 comprises one or more cloud computing nodes 1000 with which local computing devices used by cloud consumers, such as, for example, personal digital assistant (PDA) or cellular telephone 800A, desktop computer 800B, laptop computer 800C, and/or automobile computer system 800N may communicate. Nodes 1000 may communicate with one another. They may be grouped (not shown) physically or virtually, in one or more networks, such as Private, Community, Public, or Hybrid clouds as described hereinabove, or a combination thereof. This allows cloud computing environment 8000 to offer infrastructure, platforms and/or software as services for which a cloud consumer does not need to maintain resources on a local computing device. It is understood that the types of computing devices 800A-N shown in FIG. 5 are intended to be illustrative only and that computing nodes 100 and cloud computing environment 8000 can communicate with any type of computerized device over any type of network and/or network addressable connection (e.g., using a web browser).

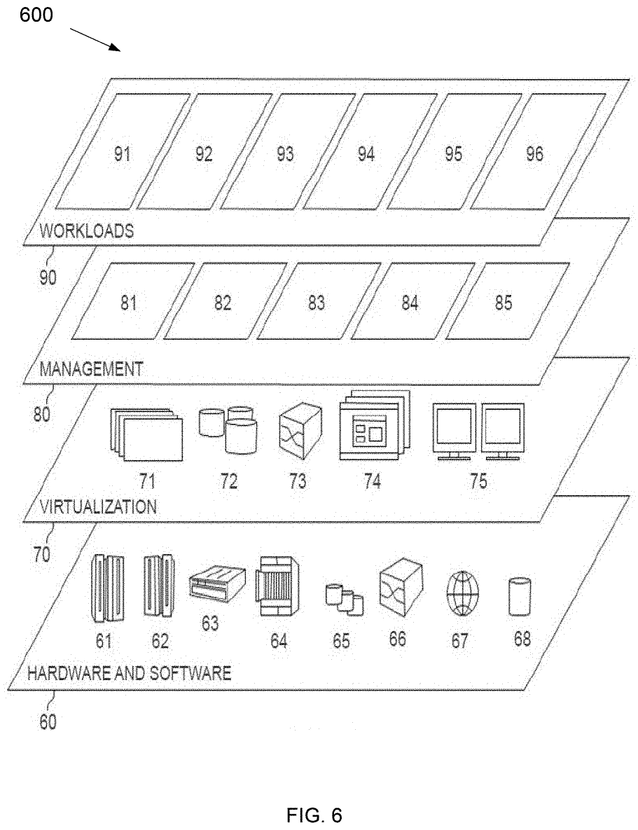

Referring now to FIG. 6, a set of functional abstraction layers 600 provided by cloud computing environment 500 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and UI navigation guide 96. A UI navigation guide program 108A, 108B (FIG. 1) may be offered “as a service in the cloud” (i.e., Software as a Service (SaaS)) for applications running on computing devices 102 (FIG. 1) and may generate a graphical navigation guide for a user interface (UI) on a computing device.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method comprising:
in response to electronically receiving on a first computing device a navigation file from a secondary computing device, generating a graphical navigation guide for a user interface (UI) associated with the first computing device based on the navigation file, wherein the navigation file comprises a sequence of computer operations based on user actions performed on the secondary computing device, and wherein generating the graphical navigation guide comprises generating computer operations for the first computing device corresponding to the sequence of computer operations from the navigation file; and
based on the generated computer operations, executing the graphical navigation guide on the UI associated with the first computing device, wherein executing the graphical navigation guide comprises displaying a screen and a UI element corresponding to the sequence of computer operations, wherein displaying the screen and the UI element further comprises displaying a sequence of different screens and at least one UI element for each screen associated with the sequence of different screens, and wherein displaying the UI element comprises rendering an overlay on the UI element that highlights the UI element on the displayed screen and instructs a user to perform an input action on the UI element.

2. The computer-implemented method of claim 1, further comprising:
tracking and capturing user action data based on the user actions performed on a second user interface associated with the secondary computing device, with the tracking and capturing being performed by UI hooks.

3. The computer-implemented method of claim 2, wherein the tracked and captured user action data is selected from a group comprising at least one of operating system (OS) data, performed computer operations data, code language data, timestamp data, screen data, screen sequence data, UI element identifiers, and metadata.

4. The computer-implemented method of claim 2, further comprising:
creating the navigation file, wherein creating the navigation file comprises storing the tracked and captured user action data as a set of sequential steps comprising the sequence of computer operations.

5. The computer-implemented method of claim 1, further comprising:
sending the navigation file to the first computing device via a messaging application; and
receiving and reading the navigation file on the first computing device.

6. The computer-implemented method of claim 1, wherein generating the graphical navigation guide further comprises:
determining, based on the navigation file, whether a first operating system associated with the first computing device is compatible with a second operating system associated with the secondary computing device.

7. The computer-implemented method of claim 1, further comprising:
in response to receiving the input action on a first UI element on the first computing device, triggering navigation to a second UI element on the first computing device based on the generated computer operations and according to the sequence of computer operations performed on the secondary computing device.

8. A computer system, comprising:
one or more processors, one or more computer-readable memories, one or more computer-readable tangible storage devices, and program instructions stored on at least one of the one or more computer-readable tangible storage devices for execution by at least one of the one or more processors via at least one of the one or more computer-readable memories, wherein the computer system is capable of performing a method comprising:
in response to electronically receiving on a first computing device a navigation file from a secondary computing device, generating a graphical navigation guide for a user interface (UI) associated with the first computing device based on the navigation file, wherein the navigation file comprises a sequence of computer operations based on user actions performed on the secondary computing device, and wherein generating the graphical navigation guide comprises generating computer operations for the first computing device corresponding to the sequence of computer operations from the navigation file; and
based on the generated computer operations, executing the graphical navigation guide on the UI associated with the first computing device, wherein executing the graphical navigation guide comprises displaying a screen and a UI element corresponding to the sequence of computer operations, wherein displaying the screen and the UI element further comprises displaying a sequence of different screens and at least one UI element for each screen associated with the sequence of different screens, and wherein displaying the UI element comprises rendering an overlay on the UI element that highlights the UI element on the displayed screen and instructs a user to perform an input action on the UI element.

9. The computer system of claim 8, further comprising:
tracking and capturing user action data based on the user actions performed on a second user interface associated with the secondary computing device, with the tracking and capturing being performed by UI hooks.

10. The computer system of claim 9, wherein the tracked and captured user action data is selected from a group comprising at least one of operating system (OS) data, performed computer operations data, code language data, timestamp data, screen data, screen sequence data, UI element identifiers, and metadata.

11. The computer system of claim 9, further comprising:
creating the navigation file, wherein creating the navigation file comprises storing the tracked and captured user action data as a set of sequential steps comprising the sequence of computer operations.

12. The computer system of claim 8, further comprising:
sending the navigation file to the first computing device via a messaging application; and
receiving and reading the navigation file on the first computing device.

13. The computer system of claim 8, wherein generating the graphical navigation guide comprises further comprises:
determining, based on the navigation file, whether a first operating system associated with the first computing device is compatible with a second operating system associated with the secondary computing device.

14. The computer system of claim 8, further comprising:
in response to receiving the input action on a first UI element on the first computing device, triggering navigation to a second UI element on the first computing device based on the generated computer operations and according to the sequence of computer operations performed on the secondary computing device.

15. A computer program product, comprising:
one or more tangible computer-readable storage devices and program instructions stored on at least one of the one or more tangible computer-readable storage devices, the program instructions executable by a processor, the program instructions comprising:
in response to electronically receiving on a first computing device a navigation file from a secondary computing device, generating a graphical navigation guide for a user interface (UI) associated with the first computing device based on the navigation file, wherein the navigation file comprises a sequence of computer operations based on user actions performed on the secondary computing device, and wherein generating the graphical navigation guide comprises generating computer operations for the first computing device corresponding to the sequence of computer operations from the navigation file; and
based on the generated computer operations, executing the graphical navigation guide on the UI associated with the first computing device, wherein executing the graphical navigation guide comprises displaying a screen and a UI element corresponding to the sequence of computer operations, wherein displaying the screen and the UI element further comprises displaying a sequence of different screens and at least one UI element for each screen associated with the sequence of different screens, and wherein displaying the UI element comprises rendering an overlay on the UI element that highlights the UI element on the displayed screen and instructs a user to perform an input action on the UI element.

16. The computer program product of claim 15, wherein the program instructions further comprises:
tracking and capturing user action data based on the user actions performed on a second user interface associated with the secondary computing device, with the tracking and capturing being performed by UI hooks.

17. The computer program product of claim 16, wherein the tracked and captured user action data is selected from a group comprising at least one of operating system (OS) data, performed computer operations data, code language data, timestamp data, screen data, screen sequence data, UI element identifiers, and metadata.

18. The computer program product of claim 16, wherein the program instructions further comprises:
creating the navigation file, wherein creating the navigation file comprises storing the tracked and captured user action data as a set of sequential steps comprising the sequence of computer operations.

19. The computer program product of claim 15, wherein the program instructions comprising generating the graphical navigation guide further comprises:
determining, based on the navigation file, whether a first operating system associated with the first computing device is compatible with a second operating system associated with the secondary computing device.

20. The computer program product of claim 15, wherein the program instructions further comprises:
in response to receiving the input action on a first UI element on the first computing device, triggering navigation to a second UI element on the first computing device based on the generated computer operations and according to the sequence of computer operations performed on the secondary computing device.
